(19) United States
(12) Patent Application Publication
(10) Pub. No.: US 2024/0370133 A1
(43) Pub. Date: Nov. 7, 2024

(54) Video Conferencing and Interface System

(71) Applicant: WiseDV Inc., San Diego, CA (US)

(72) Inventors: Atul Anandpura, San Diego, CA (US); Shuchi Anandpura, San Diego, CA (US); Bhavika Anandpura, San Diego, CA (US); Jaimin Shah, San Diego, CA (US); Yash Shah, San Diego, CA (US); Jainam Shah, San Diego, CA (US)

(73) Assignee: WiseDV Inc., San Diego, CA (US)

(21) Appl. No.: 18/681,052

(22) PCT Filed: Aug. 8, 2022
(86) PCT No.: PCT/US22/39744

§ 371 Date: Feb. 3, 2024

Related U.S. Application Data
(60) Provisional application No. 63/230,371, filed on Aug. 6, 2021.

(51) Int. Cl. G06F 3/04817; H04L 12/18

(52) U.S. Cl. CPC G06F 3/04817; H04L 12/1822

(57) ABSTRACT

A platform employing graphic interfaces which correspond to an event which are generated by a system provider. A graphic interface correlating to an event requested by users is communicated for display on a computer device of each user. Users are depicted with respective user icons on the graphic interface wherein they can choose to join groups of other users, communicate with individual other users, and view streaming video generated by other users using a drag and drop of their respective user icon to make such choices.

This application claims priority to U.S. Provisional Patent Application Ser. No. 63/230,371 filed on Aug. 6, 2021, which is incorporated herein in its entirety by this reference thereto.

### 1. FIELD OF THE INVENTION

The system herein disclosed generally relates to video conferencing. More particularly, it relates to a software enabled system employable over a computer network, such as the internet, which provides for virtual meetings and audience participatory viewing of events and the like in a user-chosen entry mode into multiple online venues, through the provision of a graphic interface adapted to such.

### 2. BACKGROUND OF THE INVENTION

In recent years with the proliferation of computing devices adapted with cameras and microphones, the employment of such for remote teleconferencing and meetings has greatly increased. This is especially true in a work environment where employees can work and attend meetings remotely using video conferencing software adapted to such.

The a software and networked environment employed for such remote video conferencing works well where it is employed in one on one settings. Conventional software employed for video and audio conferencing enable computing devices also conventionally works well in instances where multiple remote individuals who may be located in multiple remote locations, are all attending and participating in a single meeting.

With respect to the above, before explaining at least one preferred embodiment of the system herein, it is to be understood that the system invention is not limited in its application to the details of employment and to the arrangement of the components or the steps set forth in the following operational description or illustrated in the drawings. The various components and operational configurations herein disclosed for the video conferencing and viewing system herein are capable of other embodiments, and of being practiced and carried out in various ways, all of which will be obvious to those skilled in the art once the information herein is reviewed.

Also, it is to be understood that the phraseology and terminology employed herein are for the purpose of description only, and should not be regarded as limiting. As such, those skilled in the art will appreciate that the conception upon which this disclosure is based, may readily be utilized as a basis for other video conferencing and remote venue attendance systems. It is important, therefore, that the embodiments, objects and claims herein, be regarded as including such equivalent construction and methodology insofar as they do not depart from the spirit and scope of the present invention.

### 3. SUMMARY OF THE INVENTION

The system herein employs software configured to provide a software-enabled video and audio graphic interface system for employment by and between multiple users in multiple locations or venues for which a respective graphic interface page has been generated. The system and method herein provided allows for remote participation and viewing or visiting of one or multiple different video events or meetings or the like for which the system provider generates a graphic interface webpage and makes such available to users online. In all modes of the system, it employs at least one processor and one or more computer-readable storage media which includes instructions stored thereon which is responsive to execution by at least one processor and causes the system to perform the various operations herein described and disclosed. Further, for every meeting or event, the system provider will generate and make available to users an online webpage graphic interface for each respective event or meeting or the like, thereby allowing users to virtually attend with other users employing the corresponding webpage graphic interface to interact.

Such computer-readable media is employed in the conventional fashion such as including electronic memory and electronic storage. This memory and storage may represent memory and storage capacity associated with one or more computer-readable media. The memory and storage may include volatile media (such as random access memory (RAM)) and/or nonvolatile media such as read only memory (ROM), flash memory, optical disks, magnetic disks, and other memory and storage as used by those skilled in the art. Such memory and storage may include fixed media such as RAM, ROM, or a fixed hard drive, as well as removable media such as flash memory, a removable hard drive, an optical disc, and other conventional volatile and memory and storage devices. The computer readable media may be configured in a variety of other ways as would occur to those skilled in the art to accomplish the software enabled steps and method herein and as further described below.

Conventional input and output interface devices for the system herein, are representative of functionality they provide to thereby allow a user to enter commands and information to a computing device, and also allow information to be presented to the user and/or other components or devices using various input and output devices. For example and in no way limiting such conventionally employed input devices include keyboards, a cursor control device such as a mouse or trackball, a microphone in combination with voice recognition and/or spoken input, a scanner, touch functionality such as capacitive or other sensors that are configured to detect physical touch, a camera for imaging or to detect movement that does not involve touch as gestures, and other conventional input and output devices.

Examples of output devices, not to be considered limiting, may include a display device such as a monitor or projector, loudspeakers, a printer, a network card, a tactile-response device, and other conventional output devices employed in a computing environment. Thus, a computing device as herein may be configured in a variety of configurations with input and output devices and as further described below to support each respective user interaction as well as the operation of the system by the system provider.

Various steps, actions, and techniques may be described herein in a general manner for software, hardware elements, or software having modules or routines operating to execute or accomplish a particular task. Generally, such software operating to complete or perform steps or tasks may include routines, programs, objects, elements, components, data structures, and so forth, which will operate to perform the particular tasks, steps, function, or to implement particular data types. The terms “software operating to a task,” “module,” “functionality,” and “component” as used herein are to generally represent software, firmware, hardware, or a combination thereof. The features of the techniques described herein are computerized platform independent, and as such, the techniques and steps herein may be implemented on a variety of user and provider commercial computing platforms having a variety of processors.

An implementation of the described software, software modules, software operating to a task, and techniques herein, may be stored on or transmitted across some form of computer-readable media. The computer-readable media may include a variety of computer media that may be accessed by the computing device of users, participants, and system providers. By way of example, and in now way to be considered limiting, computer-readable media may include “computer readable storage media” and “computer-readable signal media.” Such “Computer-readable storage media,” as used herein, may refer to media and/or devices that enable persistent storage of information in contrast to a mere signal transmission, carrier waves, or electronic signals of such. The computer-readable storage media as employed herein, includes conventional computer hardware such as volatile and non-volatile, removable and non-removable media and/or storage devices implemented in a method or mode suitable for storage of information such as computer readable instructions, data structures, program modules, logic elements/circuits, or other data.

For example and in no way to be considered limiting, computer-readable storage media may include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture, suitable to store the desired information and which may be accessed by a computer.

“Computer-readable signal media” as used may refer to a signal bearing medium that is configured to transmit instructions to the hardware of the computing devices of users, participants, and system providers, such as via a computer-linked network. Signal media or instructions typically may embody computer readable instructions, data structures, program modules, or software running to execute a task, or other electronic data, in a modulated data signal, such as carrier waves, data signals, or other transport mechanism operational over a computer network. Signal media may also include any information delivery media. The term “modulated data signal” or “network communication” means a signal that has one or more of its characteristics set or changed in such a manner as to encode information and/or instructions in the signal. By way of example, and not limitation, communication media include wired media such as a wired network or direct-wired connection, and wireless media such as acoustic, radio frequency (RF), infrared, and other wireless media.

As previously described, hardware elements and computer-readable media are representative of instructions, modules, programmable device logic and/or fixed device logic implemented in a hardware form that may be employed in some modes of the system herein to implement at least some aspects of the techniques, steps and results described herein. Computer hardware components may include components of an integrated circuit or on-chip system, an application-specific integrated circuit (ASIC), a field-programmable gate array (FPGA), a complex programmable logic device (CPLD), and other implementations in silicon configured or other hardware devices. As such, a hardware element or component may operate as a processing device that performs program tasks defined by instructions, modules, software operating to a task, and/or logic embodied by the hardware element as well as a hardware device utilized to store instructions for execution such as for example the computer-readable storage media described previously.

Combinations of the foregoing may also be employed to implement various steps, operations, techniques, and other actions of the system described herein. Accordingly, software, hardware, or program modules or software operating to perform a specific task or step, and other program modules may be implemented as one or more instructions and/or logic embodied on some form of computer-readable storage media and/or by one or more hardware elements.

The computing devices as herein described may be configured to implement particular instructions and/or functions corresponding to the software and/or hardware running in electronic memory which operates to perform the various actions and steps of the system herein. Accordingly, implementation of software modules or software code, which is executable by the computing device as software, may be achieved at least partially in hardware, such as through use of computer-readable storage media and/or hardware elements of the processing system. The instructions and/or functions may be executable or operable by one or more articles of manufacture such as one or more computing devices and/or processing systems, to thereby implement or perform the steps, tasks, actions, techniques, and examples of the operation of the system as described herein.

The examples of employment of the system herein preferably enable the presentation of an operating environment which provides a seamless user experience when they are running the applications on a personal computer, a television device, a mobile device or another conventional computer device connected over a computer network. Services and software applications herein preferably run substantially similar in all such computerized environments in order to preferably provide a common user experience. Such allows for user transition from one device to another device while utilizing the system herein and any software or application, to attend a meeting, to view a sporting event, to have a private family movie night with multiple members, for playing a video game, for watching a video, and so on.

In the system examples, disclosed herein, multiple computing devices are preferably networked and thereby interconnected such as through a central computing device such as the provider computer or server of the system provider. The central computing device or provider computer, may be local to the multiple devices or may be located remotely from the multiple devices. In one mode of the system herein the central computing device may be a cloud of one or more server computers that are connected between the system provider and the multiple devices of users and participants through a network, the Internet, or other data communication link.

Preferably in all modes of the system herein, the network interconnection architecture for connected devices enables substantially similar functions to be delivered across multiple user devices. Such allows for the provision of a common yet seamless experience to a user or users of the multiple devices. Each of the multiple devices may have different physical requirements and operating capabilities, and the central computing device or provider computing device will employ a platform thereon, to enable the delivery of graphic interfaces and a user experience to each respective connected device which is tailored to that respective device and yet common to all devices.

While primarily described, for convenience herein, as employable for allowing multiple remote users to attended and play online games or to be a viewer of such play, such should not in any way be considered limiting. For example, the system herein is employable for any online remote viewing of one or more online venues by a plurality of users who may both attend and participate virtually, as well as having sub meetings between the participants. For example, the system is employable as an online movie theater where users can join other users in one or a plurality of user groups or as an individual. The users may view one of a plurality of movies or theatrical events in a plurality of online display screens available on the online site. Unlike a conventional movie theater, where communication during the movie is frowned upon, the system herein, using a drag and drop choice, allows users to communicate directly without bothering other users in the same group or event.

It is the ability of the system to allow multiple users to join with other users in any of the concurrently available multiple online venues and events, and to also allow for easy movement amongst multiple user groups and the easy communication between group members, which provides substantial novelty and utility to the system herein, no matter the actual site visited. Additionally, the system provider herein will employ software running in electronic memory such as computer-readable media, which in operative communication with a computer device which is engaged to a network such as the internet, to communicate computer-readable signal media between user computers and the computing device of the provider, to thereby generate the graphic interfaces communicated to each user of the system. Such which allow for a user such as a player or an attendee, or other capacity, to employ input devices to make user choices.

Each graphic interface, such as those herein provided as exemplars of the system operation, is generated by software operating to the task and running in electronic memory such as on the provider computer or service, and is communicated to the devices of respective users as they move between rooms, venues, meetings, groups and the like. Such graphic interfaces may also provide windows or defined screen areas therein for different venues, user groups, games, or the like. Any audio and video streaming to the display screens of users may also be customized by the choice of the user as to the video stream viewing perspective.

As noted, in one mode of the system, players will participate in a game and attendees who are users view chosen players in chosen venues and may do so in chosen viewing perspectives. Employed for this mode of the system, it enables a plurality of such video gamers to participate in a tournament. During such a tournament or event the users or viewers or attendees have options as to what games and players to view, each game player may also be enabled to view multiple attendee fans, and to interact with such fans via video, audio, chat, emojis, and gestures. All such options are executed by the users through a drag and drop action where they move their user icon into the room or area of the players. They may converse with other users by a drag and drop of their user icon atop that of the other users.

The system is also configured to operate to enable such remotely located users, such as video game fans, to choose and to view any one or a plurality of ongoing video games and also other individual attendees or groups of attendee fans. During such viewing each of the attendees are also enabled by the system, herein, to use the communicated graphic interface, to join groups of users and to interact with other attendees and with video game players, via video, audio, chat, emojis, and gestures. The joining of groups, changing of groups and communicative iteration between user attendees is all provided by a drag and drop action on the provided graphic interface from the system provider.

Particularly preferred in all modes and uses of the system herein, is the provision of one or a plurality of graphic interfaces, which are communicated to displays of both players and attendee users, which allows for the drag and drop mode of choice by the users. This drag and drop on the graphic interface communicated to individual users, enables such users, such as attendees who are video game fans, to easily employ the graphic interface to join and switch between groups watching the event, and to switch between different video games, theaters, events, and video game fan groups and other choices. As noted, users can choose to communicate with other users in a room or area of the event, without annoying other users therein, by a drag and drop of their user icon atop the other user. Thereafter, the system provider will provided windows to each user for text or audio and video communication whereby the users can talk during the event. The drag and drop choosing for all actions is preferred to provide a constant and easy operation by users across multiple computer devices they may have where each has differing input and output options and components and software.

In the mode of the system herein, adapted for remote viewing of live events, business conferences, movies or concerts in a theater like venue having multiple viewing rooms or screens, users may employ the provided graphic interface depicted on their computing device, to visit a virtual theater or event lobby. The graphic interface will include an entry area for newly arriving users such as a lobby. Once in the lobby, using a drag and drop mode of the graphic interface, they may choose the viewing screen, stage, or room, or other area designated on the graphic interface, which is providing the video and audio feed of the movie or event they wish to see. Where the venue or event is charging for attending, a window or other communication can be sent to the user so that the user may pay for the chosen one of the movies or events currently being screened in the theater or meeting venue.

In all modes of the method and system herein, the users may attend the meeting, concert, production or similar event, as a chosen member of a group. Upon arriving and being presented with the event graphic interface, at a virtual lobby or entry to the online venue for the meeting or performance, users may choose to join a depicted group of other users where the members of the group are positioned on the screen in a designated group. Such a designation may be a virtual room depiction or some type of graphic depiction of the plurality of other users in the group being separated from other portions of the screen venue.

The group choice by a user is accomplished by a drag and drop of the user icon or designator on the screen such as an user photo, emoji, or other designator for the user choosing. Thus, the user positioned on the communicated graphic interface outside the area on the screen where the group they wish to join are positioned, simply drags their depicted user icon or designator into the defined area occupied by the group of choice.

During the screening, or event, or speech, or other the like, the individual group members may view who the members are in their group by viewing the user icons or designators situated in their group area. They may communicate directly with each other by dragging and dropping their respective user icon or designator on the screen on top of the user icon or designator of the other party with whom they wish to communicate.

Thereafter, the system provider will provide a communication channel for the two or more users to communicate with each other by text windows which are displayed on the graphic display of each respective user, or a direct voice connection between the two computer devices such as smartphones of each user. This allows users to directly communicate with other chosen users, during the event, speech, movie, or the like, in real time in a manner which cannot be done in a movie theater, play, speaker presentation, or similar setting normally, lest the viewers make noise and upset surrounding viewers.

In a mode of the system adapted for game fans, an online game tournament may be hosted on the platform of the system provider where multiple players will come together to compete against each other. In this game mode, there are two categories into which respective site users can be divided. Either he/she can choose to be a player competing in the tournament, or they can employ the graphic interface depicted upon the screen of the user communicated from the system provider, to choose to be an attendee viewing the tournament.

A detailed disclosure of this mode of the system is represented in the multiple figures submitted herewith. In operation in all modes, users, who are attendees, once logged into the provider server or the like, either over the internet or using a smartphone application, will first be depicted in the graphic interface communicated to their device, as being located in an event lobby. In such a positioning, such users or attendees will be depicted by a user identifier, such as a user icon or shape, for example, but not limited to a square, circle, or hexagon that contains their display name and/or their photo or GIF. Once admitted to the system and depicted as located in the event lobby, user attendees can then choose to turn on their webcam at any time. In doing so, live video of each respective user attendee will be communicated to the system provider computer or server. This live video will fill or be depicted as a user view of the event, next to the user identifier or icon designated on the display screen, as related to that respective viewer or user. As noted by drag and drop choosing, other users may drag their user icon atop the depicted user view, to thereby view the event from the perspective of the chosen other user.

User attendees can also choose to turn on their microphones at any time once they are admitted to the lobby or a chosen venue from the lobby. This allows them to orally communicate by talking to other user attendees in the lobby by the drag and drop choice of their respective user icon atop that of the other user with whom they wish to communicate. From the lobby depicted on the graphic interface, communicated to each user or attendee viewing screen, they can each view all of the plurality of individual video game streams, grouped by the team, in corresponding depicted theaters or viewing rooms.

Once signed into the system and with their user icon or designator positioned in a chosen lobby, user attendees can also see the headers on each theater accessible from that lobby. The headers can have information, such as but not limited to team names, game player names, live game statistics, and their rank. User attendees, once positioned or related to a specific lobby, can either scroll/zoom in or scroll/zoom out to view other streams and labels of the teams.

Preferably user attendees, in a chosen lobby, can also see a depicted information box. In the information box, users will have chooseable features which include but are not limited to a live game map, live statistics and a leader board.

For more detailed views and in a mode allowing user attendees to interact with players and/or other user attendees, each user attendee can enter a theater or depicted venue of their choice or information box. User attendees can enter a chosen depicted room, stage, theater, or the information box by means such as, dragging and dropping their user icon or identifier, or by using arrow keys or a joystick to maneuver, or by clicking on an “Enter” button. During a game, meeting, or session, user attendees can move freely between the chosen lobby, the information box, and the individual rooms, stages, theaters and the like associated with the chosen lobby, using these same local drag and drop choosing methods

After choosing and then entering a chosen theater, or room or area of the virtual venue depicted on the graphic interface, user attendees will see in the graphic interface, a depicted stage area where the event moderator or players and their streams are located. Also shown are a floor or audience area where other users or attendees in the chosen theater are located. A depiction of the user attendees view in a theater graphic interface depiction is shown in the drawings herein.

Depicted in the graphic interface of the floor or audience area of the chosen theater or venue, user attendees may be shown in various attendee or user groups. Such depicted attendee groups consists of any number of attendees, from one (1) user attendee to all the user attendees present in the chosen theater. The user attendees will be able to view in the graphic interface communicated to their viewing screen, a depiction of the an identity such as the names of all of the user attendees on the floor of the chosen theater.

Additionally shown on the graphic interface, users can see the live video streams of all the attendees on the floor of the chosen theater who have chosen to turn on their respective cameras. The system provider, as noted, will employ software running in electronic memory of a computer system of the system provider, to receive over a network and then communicate the individual video streams available to and chosen by each respective user attendee. Such as noted is preferred by showing a window with the webcam view of a respective user, next to their user icon.

User attendees can also choose to hide their stream of videos from other user attendees outside their respective group. Audio may also be restricted by user attendee choice, to be communicated only to the other respective user attendees in a defined group of user attendees. In this mode, if a user attendee turns on their respective microphone and speaks, only those user attendees correlating to a respective group of which the speaker is a member, will hear them speak.

As noted, in the system herein, the software of the provider is configured to electronically communicate a customized graphic interface to the video display of each respective user. This will allow the respective user attendee to easily choose to move from an entry area or lobby on the graphic interface and between groups. Particularly preferred for ease of use, but not limiting, is the provision of the graphic interface which enables individual user attendees to drag and drop their respective identifier such as an icon or title, in a “join group” input by dragging their user icon into the defined area of the group. While such can also be accomplished using arrow keys or a joystick, and then clicking a “join group” button, the simple drag and drop mode of choice is preferable for ease and for a consistent experience and operation across multiple computer platforms a user may have at any given time.

In another mode of the system herein, like-minded user attendees can also create their own group, using a drag and drop interface or by means for group formation, such as but not limited to moving away from other user attendees, or by using arrow keys or a joystick, double-clicking a blank space on the depicted floor, dragging and dropping their video to a blank space, or clicking upon a graphically depicted area on the graphic interface for “Create New Group” button. The user attendees, in any group, may have the option to lock their group so that other attendees can only join the group when members of that group grant permission or invite them.

Preferred in the operation of the system herein, a graphic interface depicting a stage or performance area of the respective theater or venue chosen by users from a lobby area correlating to that theater, will include game players and their video streams. User group members can choose to spotlight the video stream generated by one player on the stage or in the chosen theater, by clicking a choice indicator such as a spotlight button, double-clicking the player's window, or similar means of choosing the video stream of a chosen player. When such a player stream is spotlighted or otherwise chosen, it will appear in a depiction of a larger video panel area, which is positioned above or below the streams of other players.

In their individual views provided by the generated graphic interface communicated to each respective user such as the attendees, the provider software is configured to allow the user attendees to independently adjust the size of the depicted stage, the positions of each video and/or stream from each player in respective windows, and the volume of each such audio or video stream of the depicted stage.

Additionally, user attendees, viewing the chosen tournament in a theater chosen by dragging and dropping their user icon from the lobby, will also have numerous options provided by the communicated graphic interface to enhance their respective viewing experience. They will not only be able to communicate with other user attendees through an in-built messenger, they may be afforded additional user-chooseable features within the communicated graphic interface on their display screen. Such additional features may include, but are not limited to, a share screen, a virtual background, a face detection, a whiteboard, and a speech-to-text conversion of an audio stream.

In a similar fashion, as explained above, a user attendee will also have an option to view the overall perspective of a running tournament of multiple players in multiple theaters correlating to those chosen from a lobby, to see how different teams are approaching each other. An example of such is depicted in the figures herein submitted.

In another function provided by the system herein, there will be a chooseable option to host trivia games with the other user attendees as players who will compete in groups or as an individual. The disclosed system herein enables a host to create trivia games in the event of having a minimum of one attendee in form of a player, from the host controls options.

Additionally provided with the system herein is the option to enable the users who are players to play the trivia quiz. They may be in groups or as an individual. User players in groups can interact with each other via video, audio, chat, emojis, and gestures. This mode of operation also enables the players to switch and shuffle between individual groups while playing trivia.

The service provider can start the trivia session by adding multiple questions for the quiz. To that end, there will be two ways for adding questions. In one mode of operation they may be added manually, and in an alterative mode of operation spreadsheets having questions and options in a standard format may be imported and employed. Such multiple questions may be input to an excel template, and a sample may be provided to explain how to create questions with options and correct answers on such a spreadsheet.

Such generation of trivia questions is depicted in the figures, herein, such as FIG. 4. That figure explains the provider or host view while creating trivia. As shown, a user will employ the communicated graphic interface to select either to import questions, or to add questions manually as desired. A sample template can be held in electronic memory and can be downloaded to a requesting user to use as a format for importing questions via a spreadsheet. Attendees from the lobby can join those on the theater floor to become the player of trivia.

In another mode of the system herein, adding the Trivia questions for a contest may be accomplished manually. It supports images as well as video files in the form of questions and answers and upload files of the maximum size mentioned while creating the database. A minimum of two options are necessary to add per question. Questions and their options can be edited or deleted from the list. The host may drag and drop the questions up and down to change the sequence. Some players on the floor are individuals, and some are in groups. Attendees in the lobby can view floor players and can join any group or can create their own individual group to play trivia.

The host of a trivia game or contest will have options such as reveal options and skip to the next question options for conducting the trivia game. Players playing the trivia game individually or in groups must answer the question in the given time. The host can view the live statistics while hosting a trivia game or contest.

A detailed depiction of such contest options is represented in the figures herein. Players, such as user attendees, can change and shuffle their group or can play individually while playing the trivia game. During the game, the host first asks a question and then reveals the options with which the timer starts. Upon completing the set time, the host reveals the correct answer and then moves to the next question. The host has the right to pause or stop the trivia game at anytime. The host will be able to view the statistics of the ongoing Trivia and Leader board at any given point.

FIG. 7 depicts the player side view of the communicated graphic interface while playing the trivia game. Players can chat and talk to each other within the group by turning on their microphones and webcams while answering the questions. Their voice and video can be restricted to other players and groups and vice-versa. Players can hear only the Host and their group members while playing the trivia game. The last selected answer for the question by any team member in the set time range will be counted as the final answer. Live selected answers by the group member status are shown to the player. A player can stop the trivia game anytime as well as a player can view the leader board anytime while playing the trivia.

The depicted leader board on the graphic interface communicated from the provider to users, such as trivia game players, shows the ranks of the players to the host of the trivia game. Also depicted are the identifiers of the players at any time while the trivia game is running or after the trivia game ceases. After the trivia game ends, the leader board is automatically displayed showing the respective players' ranks to the host of the trivia game. A player is shown his/her rank in the leader board with the time taken to answer all the questions. It also shows other players' ranks being in groups or individuals.

An example of a depiction of such is shown in FIG. 8. It counts the correct answers with a minimum duration of time taken to complete all questions by all players. Players positioned at the end of the trivia game are considered on the leader board. Players can get the results of their selected wrong and right answers by selecting the View Correct Answer option.

With respect to the above description, before explaining at least one preferred embodiment of the system herein, it is to be understood that the invention is not limited in its application to the details of operation nor the arrangement of the graphic interface or the components or the steps set forth in the following description or illustrations in the drawings. The various methods of implementation and operation of the system herein, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other networked software enabled systems for carrying out the several purposes of the disclosed video and conferencing system herein. Therefore, that the objects and claims herein should be regarded as including such equivalent software, steps, and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, the term “substantially” if not otherwise specifically defined for size or dimension or positioning of a specific part or configuration, means plus or minus ten percent.

It is an object of the invention herein to allow people the ability to enjoy watching online tournaments of different games played by gamers or players, through the provision of a software enabled system over a network which provides a graphic interface rending it easy for user attendees to join and explore the game from a player's side, thereby providing users the experience that they are part of the tournament

It is another object of this invention to provide a network accessible system enabling the tournament players to showcase their intelligence and interest in playing games and giving competition to other teams and players, while concurrently viewing their fans, their competitors, and interacting with all of them via video, audio, chat, emoji, and gestures.

It is another object of the system herein to provide users a graphic interface which easily enables attendees, such as game fans, to show appreciation for gamers' skills in order to boost and encourage the viewed gamers to showcase their skills while being able to concurrently watched by their fans.

An additional object of this invention is the provision of graphic interfaces to users who wish to virtually attend an event, which enables the users a drag and drop choice of multiple options to provide for a common operation across multiple computer platforms a user may have and employ.

These together with other objects and advantages, which become subsequently apparent reside in the details of the construction and operation of the system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF THE DRAWINGS

The accompanying drawings, which are incorporated herein and form a part of the specification, illustrate some, but not the only or exclusive, examples of embodiments and/or features of the various modes and steps of the software enabled networked video conferencing and communication system herein, which as noted may be employed singularly or in combination. It is intended that the embodiments and figures disclosed herein are to be considered illustrative rather than limiting.

In the drawings:

FIG. 1 is a schematic view of an exemplar of a graphic interface which is communicated to users which corresponds to a respective event at a venue and is shown as an exemplar of such for a game tournament showing a main view or dashboard depicting the lobby entry area and different grouping or locations of users in the venue such as teams in sessions, players, and user attendees, as they join the event from initial depicted entry into a lobby area by drag and drop of their respective user icon.

FIG. 2 is the view of a communicable graphic interface corresponding to an example of an event at a venue in the form of a team session showing participating team players and a game view window showing a current game, along with depictions of user attendees who chose to join the session in sub groups and are shown as able to watch the game from their own selected view or the view of another selected player's perspective using the drag and drop of their user icon.

FIG. 3 depicts an exemplar of a communicated graphic interface corresponding to a view of an event at a real or virtual venue where the graphic interface depicts an overall session of a game, where all the teams' players and user attendees are depicted on one page along with the main tournament game view, and showing all the players playing the game from a respective overall perspective chosen by a drag and drop of their respective user icon.

FIG. 4 shows an example of a view of a graphic interface generated by the system provider corresponding to a virtual venue which may be communicated to users logging into such, depicting a schematic view of the host area and showing the options for user attendees to add questions by drag and drop of their respective user icon, for the trivia quiz or game, and showing participating user attendees waiting on the Floor area or in the Lobby area.

FIG. 5 is the view of an example of a system provider generated graphic interface communicated to users depicting questions added by a venue host manually for a Quiz of users, which can be shuffled and can be edited, or deleted, and showing the Players on the Floor area ready to play Trivia by drag and drop of their respective user icon to group or depicted as an individual.

FIG. 6 is the view of an example of a system provider graphic interface of a virtual trivia game venue communicated to users logging in, showing ongoing Trivia from the Host side, where a question may be asked to the players with the timer, and where the Host has different employable controls to reveal options, answers and to go to the next question and users will participate by drag and drop of their respective user icon.

FIG. 7 depicts an example of a system provider generated graphic interface which corresponds to a virtual venue communicated to users logging in, of an ongoing Trivia game from the Players' perspective, where the user player/attendee can be depicted in a group chosen by drag and drop of their icon, and has selected an option for the question conducted by the Host while still interacting with their own group members.

FIG. 8 shows an example of a system provider generated graphic interface communicated to users which is in the form of a Leader board from the Player side displaying their respective positions and time taken in the ongoing Trivia to answer the given question.

FIG. 9 is a graphic depiction of the operation of the system herein through the provision by the system provider of graphic interfaces corresponding to a meeting or event or the like occurring at a physical or virtual venue wherein users are enabled to take any of multiple choices by a drag and drop of their respective user icon to join groups, join audiences, communicate directly with individual other users, and other choices enabled by their respective drag and drop actions.

### DETAILED DESCRIPTION OF THE PREFERRED EMBODIMENTS

In this description, the directional prepositions of up, upwardly, down, downwardly, front, back, top, upper, bottom, lower, left, right, first, second, front, rear, and other such terms refer to the system and graphic interface as it is oriented and/or appears in the drawings and are used for convenience only, and they are not intended to be limiting or to imply that any depictions on the graphic interface employed by the system have to be used or positioned in any particular orientation.

Additionally, as noted, while for convenience of description, the specification and drawings herein primarily describe the system provider generated graphic interface system which generates respective graphic interfaces corresponding to respective individual events. By events is meant any event, contest, sporting event, speech, or the like where a group or audience or crowd may watch and/or participate in the respective event. The system herein, thus, provides a virtual venue system where using system generated graphic interfaces corresponding to each event, users can make choices as to interaction and viewing by employment of a drag and drop choice.

While many of the exemplars and descriptions herein describe a system employed for gaming, such is for convenience of explanation and in no manner should be considered limiting. The system is also employable wherever a graphic interface corresponding to an event at a real or virtual venue may be communicated to user attendees, and thereby enable them to join or interact with a group of users using the same graphic interface corresponding to the same event. Such other virtual and actual venues for example and in no way limiting can be any of a game or sporting event, a movie in a theater, a play, a concert, a wedding, a little league game, a broadcast TV show or movie, or any other event communicated to multiple users concurrently at different locations using the graphic interface generated by the system provider for each event. Such may, for example, be a movie night for family in different states or any other venue where people attend to view one or a combination of activities together and/or in segmented groups, or any other activity occurring in a physical or virtual room. The users may actually be attending an event, such as a baseball game or wedding, or they may be remote to the event for which the graphic interface generated and being used by all users for such an event respectively corresponds.

The user logging in and requesting participation in an event for which the system provider has generated a corresponding graphic interface, will be immediately assigned a user icon upon entering the lobby or dashboard area of the graphic interface communicated to their computer device for the corresponding event or virtual chosen venue. The user icon can be any chosen by the user or by the system provider, such as a photo of the user. Thereafter, using a drag and drop action, each respective user may make their respective choice for their actions and positioning on the graphic interface. This user choice along with choices for communicating with other users directly and choosing a depicted view of the event, along with all other actions is actuated by the dragging and dropping of the respective user icon of each user.

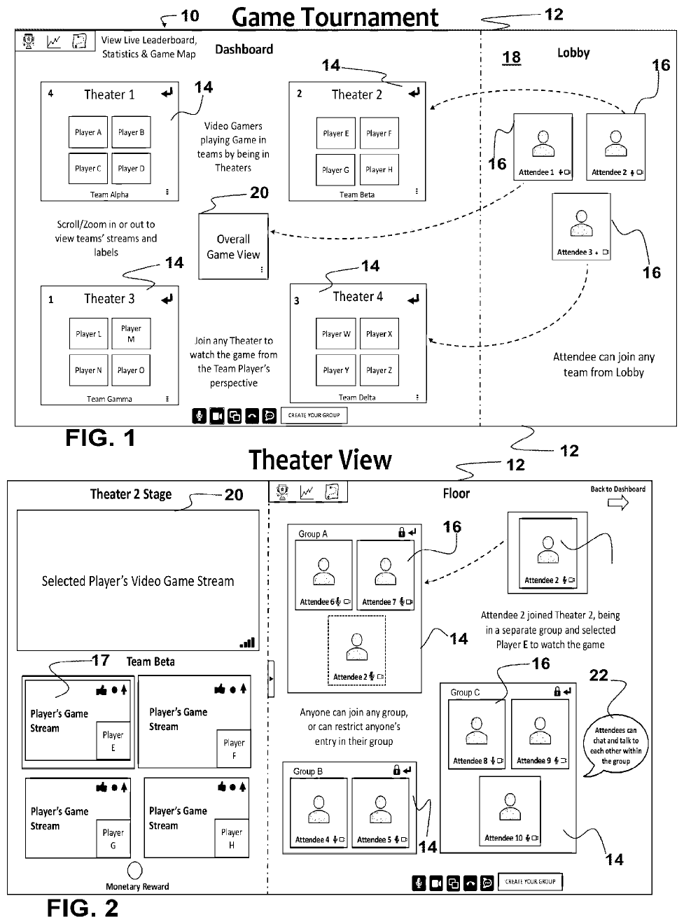

Referring now to FIG. 1, there is shown an example of a system 10 where the system provider has generated a graphic interface 12 corresponding to an event which may be communicated to users of the system herein logging in and requesting such. The logging in and requesting of the event graphic interface may be done in a conventional fashion where users may provide information concerning the event, or for example, they may scan a bar code or QR code which will connect their computing device to the server of the system provider and concurrently request attendance at a specific event for which the system provider has generated a graphic interface 12 relating thereto.

As noted, the generated graphic interface 12, from the system provider, may correlate to any event occurring at a designated time at a real or virtual venue, which will allow for multiple users to physically and/or virtually congregate. The event, for example, may be an actual game such as a baseball game where some users are located in the stands of the stadium and other users are not and are located remote to the actual game venue. The event, for example, may also be a virtual event, with no physical venue, but occur at a time for which a graphic interface for requesting users is generated and communicated to users logging in and requesting attendance at such. In the depicted game mode of a graphic interface of the system as shown, sixteen players are participating and they are depicted as divided among four teams, with each depicted team shown in an individual theater hosting four respective players.

In any case, the use of event herein, as noted, means any actual event such as a game, concert, speech, theatrical event, or any event where an audience will gather to watch something in common which may be broadcast by the system provider and depicted in an event depiction window. The event may also be a virtual event where some or all users and participants are located remotely, and participate using the graphic interface generated by the system provider which correlates to the respective event. For example only, a quiz show for which players or participants are present at a location or remote, and user viewers may be remote, or, a movie broadcast on a television network or streaming from a provider where family members or friends are in remote locations and may watch the movie in the event depiction window while joining in communications between family or friends initiated by drag and drop requests for such.

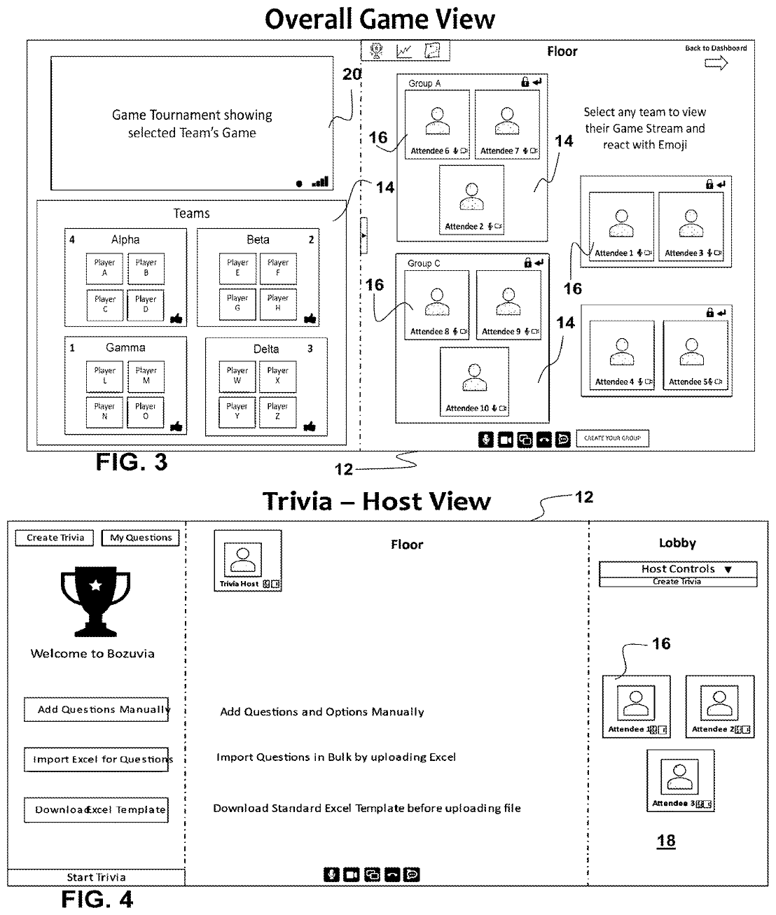

As shown in the example of a game in FIG. 3, a graphic interface correlating to an event 12, such as a game, has been generated by the system provider which is communicated to all requesting users. A first group of participant users, shown as Team Alpha, is positioned within a participant area 14 of the generated interface, marked theater 1 and consists of four users or players: Player A, Player B, Player C, and Player D. Also depicted in the participant area 14 is a second group of users shown as Team Beta, which is shown positioned within an area of the graphic interface designated theater 2 and consists of four users or players: Player E, Player F, Player G, and Player H. Shown positioned within the participant area 14 is an area designated theater 3 is a third group of users shown as Team Gamma which is shown having four other users or players: Player L, Player M, Player N, and Player O. Finally, positioned within an area of the participant area 14 designated theater 4 is a fourth group of users shown as Team Delta which also includes four users or players: Player W, Player X, Player Y, and Player Z.

Each team shown as a separate group on the graphic interface 12 is playing a game or in a competition, which is of interest to the user attendees who join the session by using a mouse or controller to move their user identifier or user icon 16, such as an identifying icon, from the lobby area 18 of the graphic interface 12, to a theater of choice, to enable them to view a game and the players they wish to watch who are located in any of theaters 1-4. In addition, there is provided an event depiction window 20 section of the communicated graphic interface 12 which is designated an overall event view or game view. This overall game view shows the ongoing audio/video stream of the event, such as the interaction of all four teams competing against each other. The choice to move into a respective theater may also be chosen by one of the lobby-situated attendee users correlating to their user icon 16 by a drag and drop of their user icon 16 thereon.

As shown in FIGS. 1-2, user attendees to the event for which the graphic interface 12 correlates, upon logging into the system, will first be depicted on the screen by a user identifier such as their user icon 16 or shape entering a non assigned lobby 18 area or waiting area. Their respective position in the lobby area is communicated to the graphic interface on the display of each user attendee. From this position, each user attendee can view the same graphic interface which shows the other respective user attendees located in the lobby 18 area and depicts the plurality of different teams playing in that tournament, located in the participant area 14 within the different respective theaters with different groups of players.

Using their respective graphic interface 12, each user attendee can move their respective user icon 16 depiction from the lobby 18 area to thereby join and view any team playing in a tournament by simply dragging and dropping their user icon 16 or other identifier from the lobby 18 area to the chosen theater or game view area. Using the graphic interface 12 communicated over a network from the server or computing system of the system provider to each respective user, a user attendee, once assigned a user identifier, such as a user icon 16 or shape, showing their position in the lobby 18 area by the system, can thereafter also join the overall game view to understand the position and perspective of each team's game in progress.

As an example, as shown in FIG. 1, user Attendee 2, having their respective icon or user identifier located within the lobby 18 area, chooses to join the theater 2 of Team Beta by dragging their respective user icon or identifier into the area shown as theater 2. Once joined to theater 2, user Attendee 2 is given the option to watch the game played by the players (either E, F, G or H) but from the chosen player's perspective view in that respective theater.

By dragging and dropping their individual respective user identifiers such as a user icon 16 or shape, user Attendee 2 can, for example, select player E from the team Beta within theater 2. Once so selected, by dragging and dropping their user icon onto the player E icon or designator, thereafter, that user attendee will be provided a screen depiction of the game within the event depiction window 20, as shown in FIG. 2, which depicts, in real time, the ongoing competition with the other players.

In an especially preferred mode of the system 10, a user correlating to a user icon 16 can be communicated a video stream of the play of the game, from the perspective of player E on which they dropped their user icon, where player E has a camera or smartphone or the like which is capturing a video stream of the game. Similarly, other user attendees who are also present may use their respective user icons 16 to choose and then watch respective games of their selected player in a chosen theater where that player is playing. If a view of the event or game or the like from a player or attendee position is chosen it will be shown in the event depiction window 20 instead of the default view therein of the event. Where users or attendees are in different areas of a baseball or football stadium, the option for users to move their user icons 16 and select the view from different angles provides each the ability to view the event from multiple angles and positions which the overall default video stream shown in the event depiction window 20 may not provide.

User Attendee 2 has an option to either view the game alone, without interacting with anybody, or they may choose to join a user group, depicted in FIG. 2 as group A or B or C. As shown, for example in FIG. 2, user Attendee 2 uses the communicated graphic interface 12 to drag and drop their user icon 16 or identifier overlain on a group to make a choice of groups. Once so joined, user 2 is connected with and can interact with individual attendees 6 and 7 who are in an area where user 2 has dragged their user icon 16. This interaction is initiated by the user dragging their user icon 16 onto the other user in the group allowing user 2 to directly communicate with users or participants in the group via video, audio, chat, texting, emojis, and gestures. Such is accomplished by user 2 dragging their user icon 16 atop that of one of the attendees in the designated section. The system provider will provide the choosing user and the chosen user or participant with a communication connection by one or a combination of video, audio, chat boxes, and text boxes which appear on both the viewing screen of the choosing user and the chosen user.

In making the choice using the communicated graphic interface in an especially preferred mode, user attendee 2 joins group A, by the simple action of dragging and dropping their respective user icon 16 identifier depicted on the video display, into the area designated group A. Alternatively, but not as preferred, by similar means of choosing, user Attendee 2 can be given a graphic interface on their display enabling them to operate an “Enter” button residing on top of the group.

As noted, software running in electronic memory, operatively communicating with a computer of the system provider, and each of the computers of each of the users, continuously monitors the respective input signals from the input components on the computing device from each respective user employing the communicated graphic interface 12 on their respective displays, to move their user icon 16 or identifier about, and thereby initiate the communication software actions to connect them with other players in the fashion chosen by each respective user of the system.

As shown, user Attendee 2, while viewing a video stream in the event depiction window 20 of team Beta, while associated with Group A, can listen to the audio of group A members user Attendee 6 and user Attendee 7. However, using software adapted to the task running in the computer memory of the system provider, group A audio communication can be chosen to not be audible to any other groups.

The system provider employing software running to perform the task, can optionally allow members of group A, to employ choices depicted on the respective graphic interface 12 communicated to their respective user displays, to restrict their respective camera video stream, only to their group or any other group at discretion. Additionally, Group A can be provided with a graphic interface input to allow them to choose to lock their group, so that any other user attendees cannot join their group without their consent.

Any user attendee having input their choice to join Group A to their respective depicted graphic interface, can leave Group A by a drag and drop action of their user icon 16. Alternatively, they may also be provided with an input on the graphic interface communicated to them, to allow them to join another group, or to form their own group. User attendees such as Attendee 2, once they have chosen theater 2 and team beta as in FIG. 1, can message Team Beta or Player E, F, G, or H individually by dragging their user icon 16 atop that of the players which will cause the software of the system provider, to provide messaging windows 22 in which two way or multiple user communications will occur. The messaging windows 22 will only appear on the graphic interface 12 of the users who have requested the messaging when one user drags their user icon 16 atop the depiction of another user or attendee on the graphic interface 12 correlating to the event.

In another action available to users, who are attendees, in order to encourage Team Beta to perform at their peak, user Attendee 2 can show their support of a team by offering monetary rewards, which are transferred through any financial transaction means including but not limited to credit card, debit card, E-Pay like Venmo, Zelle, CashApp, to name a few. In addition, monetary rewards can be in the form of crypto tokens, cryptocurrencies, and tournament platform-specific virtual coins. The tournament provider platform will employ software running in electronic memory and appropriate commuting components and network connections, to support internal betting among attendees or groups if permitted by laws.

At the end of game play, a depiction of a leader board within the graphic interface 12, correlating to the particular event, may be communicated to all user attendees and will show the standing of the teams. The Leader board will be calculated based on the spectator's/attendee's contribution, either through the monetary collection or likes and emojis, in addition to the traditional game scoring. To apply non-traditional game scoring factors, artificial intelligence will be used.

Game tournaments may consist of single or multiple day play where round robins or knock-out tournament rules can be applied to determine the winner from the plurality of user players and teams participating. Additionally, the system provider can procure various types of sponsors who are determined as wanting to promote a team or an attendees group, by providing monetary compensations in exchange for any type of brand or sponsored advertisements. A user or player attendee can also share the advertisements with different attendees which in turn will be acknowledged by the sponsors and the forwarder attendee will be additionally compensated by the respective sponsors

Once logged into the system of the provider, any user attendee can select a ‘Back to Dashboard’ option to move their identifier such as an icon 16 or depiction, back to the Dashboard area of the graphic interface 12 such as in FIG. 1, and for example into the lobby 18 area thereof. Once so positioned, user attendees can make the choice to join other team sessions in any depicted respective theater where a game is played. Once within the chosen theater, they may view the chosen game from the other player's perspective via a video stream of the game communicated to them by the system. All such choices are by drag and drop of their respective user icon 16.

A user attendee, once logged in and depicted by their user identifier on the graphic interface 12 as being present, and joining the overall game view session, may, for example, lead that user attendee to that session, as shown in FIG. 3. As shown in FIG. 3, the user Attendee 2 has input the choice to the graphic interface 12 to join the overall game view session in group A. The user icon 16 correlating to Attendee 2 is now depicted as a member of Group A with other user attendee members shown as participating in group A. In FIG. 3 is also shown the user icons 16 of the other user attendees who joined the tournament FIG. 3 which also depicts all the teams playing the game with their respective name tags.

Based on the common view and position of each team, depicted in the common view of the system generated graphic interface of the event in the event depiction window 20, Attendee 2 can employ the drag and drop action of the graphic interface to select team Delta while Attendee 1 and other attendees will have the option to view or switch from overall game view to different teams view. Live streams of the game play can be chosen to be delayed, which could be but not limited to tournament factors, gamers' choice, or any other related reasons.

Tournament video streams depicted in the event depiction window 20 may be recorded with the consent of the gamers and attendees. Recording of the tournament may be composed of individual gamers' video streams and overall views generated by the tournament or event organizer in such a way that a user attendee can relive the experience by watching the same team again or by watching a different team.

The replay view of the recorded tournament is programmable. For example, Attendee 2 can replay the tournament by selecting team Alpha or any other team instead of watching Team Beta, which was viewed live earlier

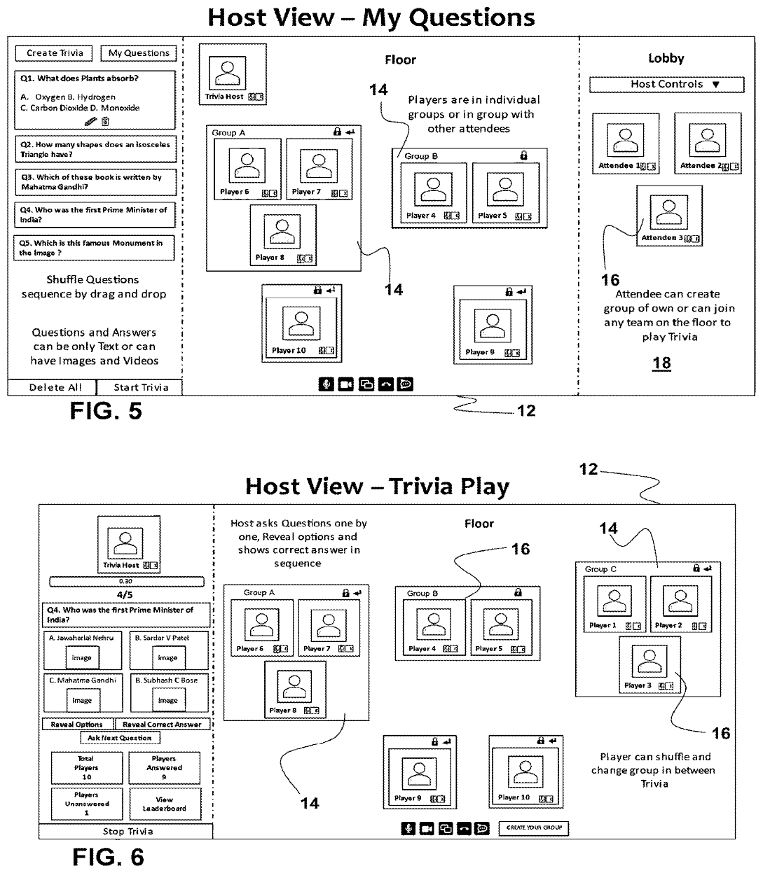

Referring now to FIG. 4, a host has created a trivia game as an event to which a graphic interface 12 correlating thereto has been generated by the system provider from the option available under Host Controls. At first, the host needs to add questions manually or refer to the excel template and then import the questions into an excel file. Imported questions, in standard format, will automatically be added in the My Questions section. User attendees, once their user identifier or icon or the like is positioned in the lobby, have to join the Floor to become a player. Operating the trivia game in a similar fashion to that of FIG. 4, questions may be added by a host manually. As shown in FIG. 5, the host may manually add questions and options one by one.

Referring to FIG. 6, the host in this depicted example, may add multiple questions with four options to each question. Images and videos are also supported with the text for questions and answers. To shuffle the sequence of the questions, the host can employ the depicted graphic interface 16 to drag and drop the questions in the list up and down. The option to edit and delete the question is given to the host to make changes. Some user attendees who are players on the floor, have created groups to play the trivia game, and some will play individually in their own group. Starting the trivia game by the host will lead to starting a quiz, shown in Figure A.

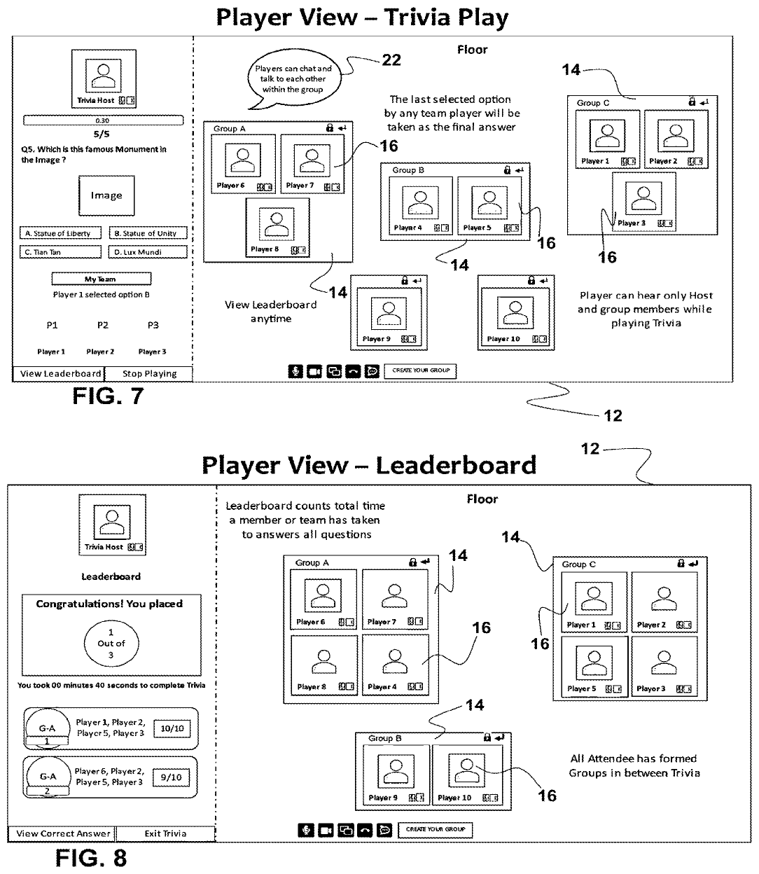

In FIG. 7 is shown the example of the system where the graphic interface 12 generated correlates to the trivia game display depiction from the host side. In this mode, the host will ask questions in sequence, reveal options with which the timer will start for attending user players to answer the question. After the timer goes off, the host will reveal the correct answer and will move further to the next question. A player using the drag and drop action with their respective depicted interface, can shuffle and change their group while playing Trivia.

In FIG. 8 is shown an example of the trivia game view of the graphic interface correlating thereto, but shown from the attendee or player side. As shown, a player can hear audio only from the host and from their group members while playing the trivia game. The respective groups of the players can restrict their voice and videos within the group. Players in each group can also restrict and lock their group so that other players cannot join their group. Players can chat and talk to each other for discussing answers while playing trivia. The last selected option by any of the team members of a group, within the time limit, will be considered the final answer to the question.

During a trivia game session, anyone can view the leader board anytime while the trivia game session is running or it will be automatically displayed after a trivia session ends. The leader board counts the correct answers with a minimum duration of time taken to complete all questions by all players.

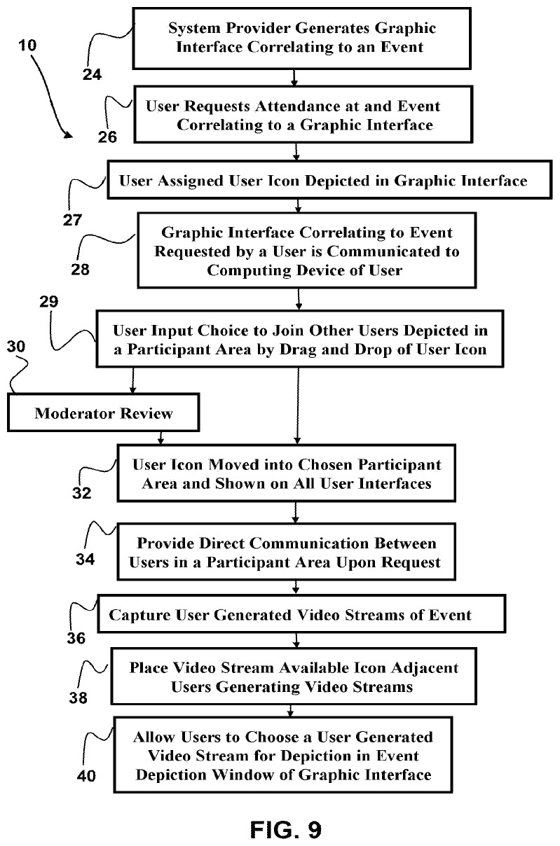

FIG. 9 is a generalized graphic depiction of the system 10 herein wherein the system provider is running software operating to the tasks and steps herein on a network connected server or computer will generate a graphic interface 24 which correlates to each event. Such graphic interfaces correlating to an unlimited number of events can be generated and held in electronic memory wherein they are communicated over a computer network to users requesting attendance at an event correlating to a graphic interface 12.

When a user logs into the system by contacting or visiting the site or server of the system provider, they may login and request attendance 26 at an event for which the system provider has generated a graphic interface correlating thereto. Upon detecting a communication from each user requesting to attend an event, the graphic interface, generated by the system provider corresponding to the event and depicting the event venue in a graphic form, with a user identifier assigned 27 and depicted in a lobby of the graphic interface, is communicated to the computing device of the user 28 over a network.

Thereafter, each respective user is assigned a user icon or identifier 27 which is depicted in the communicated graphic interface as located initially as positioned in a holding area, shown as a lobby 18 of the graphically depicted venue. As noted, the graphic interface communicated to users requesting such, which will correspond to a respective real or virtual event, and preferably will have an event depiction window 20 therein to provide each user a live feed of the event such as a game, political event, community meeting, or a movie or show being broadcast to all users is to be depicted.

Also depicted on the graphic interface corresponding to the event and generated by the system provider and communicated over the network to the computing devices of each user, are depictions of defined areas or participant areas 14 showing one or a plurality of user groups with the user icons 16 of joined users therein. Using the graphic interface generated by the system provider, which corresponds to the event, the depicted venue communicated to and depicted on the display of the user computing devices, each respective user can view their user icon 16 initially in the holding area or lobby 18 or other area of the graphic interface 12. This action confirms to each user they have successfully logged into the requested event for which the corresponding graphic interface 12 has been communicated to their computing device by the system provider.

Also preferably depicted in each graphic interface 12 so communicated are an audio/video stream within an event depiction window 20 which will show a video depiction of the event in progress. For example only, the event depiction window 20 may show a baseball game in progress, a quiz or game show in progress, a movie or the like being watched by users who are a family or group of friends, a wedding, a class reunion, or any event for which an audio/video is provided by a broadcaster or user or is generated or provided by the system provider.

In a next step, using the system provided graphic interface correlating to the event for which the user requested attendance, the user be allowed to employ the correlating graphic interface in a drag and drop of their respective user icon 16 in to communicate to the system provider a first choice 29 to move from their initial positioning in a holding area or lobby 18 and into participant area 14 or a group area depicted on the graphic interface 12. Such group or participant areas may be one or a plurality of defined areas shown on the graphic interface 12 which depict the user icons 16 of other users as present in that group or participant area 14. This allows users entering and depicted on the event specific graphic interface as being in the unchosen area or lobby 18, to easily move to a user group or participant area 14 or other chosen area depicted on the graphic interface in an easy drag and drop movement of their respective user icon 16.

In all modes of the system 10, for any event for which a graphic interface 12 correlating thereto is generated and communicated to users by the system provider, a moderator 30 may be provided by the system provider or the event organizer. This optional step is preferable in many cases to maintain order or timely progression of the event and the like but is not required. Where provided the moderator 30 will view each the user icon 16 correlating to each new user entering the lobby 18 on the graphic interface 12. Subsequently, the moderator will view each choice 27 of each user to move from that lobby 18 to a user group or participant area 14 or other area of the event specific graphic interface. The moderator, if provided, may prevent the request actuated by a user to move from the lobby area to a specific user group area wherein they will remain in the lobby and a message will be communicated to the user their choice was not fulfilled.

Where the moderator 30 is employed and approves, the user icon 16 of the requesting user will be moved into the chosen participant area 32. If no moderator is employed, then subsequent to the first choice 28 of the user to join other users in a designated participant area, the user icon of the requesting user will be moved into the participant area 30 on the user interface of the choosing user and all other users already logged into the event.

In subsequent steps, each of the plurality of users using their respective user icon 16 in the drag and drop action may choose to move to another depicted user group or participant area 14 by the dragging and dropping of their user icon to the chosen group or participant area 14.

Once depicted, with their user icon 16 as positioned in any user group or participant area 14, all users shown located therein, have the option of requesting direct private communication 34 with one or more other user members having respective user icons 16 depicted in the respective user group or participant area 14. This direct communication 34 is initiated by any user with their user icon 16 depicted in the user group or participant area 14 through a drag and drop of their respective user icon 16, atop the pixels depicting the user icon 16 of another user shown in the graphic interface as being in the user group or participant area 14. Software running to the task of opening a direct communication channel between the requesting user and the requested user will cause the depiction of a communication window 22 on the graphic displays of each user for which such communication was requested. Such communication between the computing devices of the users may be by one or a combination of voice, text, video, and other forms of electronic communication. Thereafter, using text, video, audio, or combinations thereof, a stream of communication is enabled between the choosing user and the chosen user or users, where they may directly communicate with one another without communicating or showing such communication to the other users in the group area. This direct communication between users is only enabled on the graphic interfaces depicted on the computing device of the choosing user and the chosen user or users.

Where the system is employed, for example, for multiple users to watch a movie, which is depicted on the event depiction window 20 in the graphic interface 12, such would work well for friends and family members to all login as individual users where they each will be assigned a user icon 16 which will appear on the communicated graphic interface 12 from the system provider, to each respective computing device of each respective user. Thereafter, the users may form one or more user groups by dragging and dropping into a respective participant area 14, and move therebetween by the drag and drop action. Newly arriving users who subsequently login will have their respective user icon 16 depicted in the lobby 18 on all of the graphic interfaces of the users, and they can choose by drag and drop their user icon 16 to join the other respective users in a user group or participant area 14. Only once depicted by their respective user icon 16 as being moved into a user or participant group 14 on the communicated graphic interface 12, may an individual user request the opening of communication channel by the system provider with another chosen user or users. For families or friends watching the movie or event, it allows some to converse on the provided direct communication channels with others are left to watch the event without interruption or to converse with other chosen users.

Where the event for which a corresponding graphic interface has been generated is for example a concert or sporting event, the live feed of the event for example from a TV network, the concert provider, or the system provider will be depicted in the event depiction window 20 on each graphic interface of each user. Once a user moves from the lobby 18 to their chosen user group or participant area 14, they may initiate the direct communication with other users having their respective user icon 16 shown in that participant area 14.

In a particularly preferred mode of the system, where users are attending an event such as a baseball game or soccer game, wedding, or the like where different users have their own video cameras to capture the event video in real time, such as using a smartphone camera, in another step, the real time video stream from each user with a webcam such as a smartphone or other video capturing device is communicated to the system provider 36 as a video stream associated with the user in their respective position at the venue.

Once initiated by communication of the video stream by a user from their position, the system provider will generate a small window or stream denoting icon 38 adjacent the user icon 16 of the user generating the video stream and showing the respective view from the camera of an individual user which will be depicted adjacent their respective user icon 16 on all the graphic interfaces communicate to all users. This shows that a separate video stream from that user in the event depiction window 20 is available to all users. The video stream may also include audio to go along with the video depicted in any such video stream.

Thereafter each user having their user icon 16 depicted on the graphic interface 16 correlating to the event, can choose to watch the event in the default video stream provided event depiction window 20 as broadcast by a network or the system provider. Alternatively they can choose to watch the event in the event depiction window 20 from the view of the user generated video stream 40 from a respective user broadcasting it from their camera or phone. This is accomplished by a drag and drop of their user icon 16 of a choosing user, atop the depicted video stream icon 17 located adjacent the user icon 16 of the user generating the user video stream. Thereafter the video and any audio of the event shown in the event depiction window 20 will change to the view being captured by the webcam or smartphone or video capture device at the location and viewing angle of the chosen user video stream. This step option of allowing users to choose a user generated video stream 40 is particularly preferred to allow some users to capture and communicate a user generated video stream of an event to the system provider from differing view points where other users can choose to view the event from those viewpoints, or to simply view the event as broadcast and shown in the event depiction window.

The description of the features of the system herein, does not limit the claims of this application, and, other applications employing software over a network to enable user attendees to choose groups and/or games or other events accessible from a common entry lobby developed by those skilled in the art upon reviewing this application are considered to be included in this invention.

It is additionally noted and anticipated that although the depictions and disclosure herein provides a disclosure of the system herein in its most simple form and operation, potential configurations, various other graphic interfaces and aspects of the disclosed system may be differently arranged or slightly modified when forming the system herein. As such, those skilled in the art will appreciate the descriptions and depictions set forth in this disclosure are merely meant to portray examples of preferred modes of the operation and user interaction of the system herein within the overall scope and intent of the invention, and are not to be considered limiting in any manner.

Further, while all of the fundamental characteristics and features of the network interface system for attendees and participants in one or more remote events, have been shown and described herein, with reference to particular embodiments thereof, a latitude of modification, various changes and substitutions are intended in the foregoing disclosure as well as the claims which follow, and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions in the operation of the system and graphic interface interactions and depictions are included within the scope of the invention as defined by the following claims.

What is claimed is:

1. A system comprising:
a system provider having a server having at least one processor; and
one or more computer-readable storage media including instructions stored thereon that, responsive to execution by the at least one processor, cause the system perform operations including the steps of:
generating a graphic interface correlating to an event;
detecting a user in a communication session to said server of said system provider requesting attendance at said event;
communicating said graphic interface correlating to said event to each said user in a plurality of users, where said graphic interface initially depicts a user icon correlating to each respective user which is positioned in a lobby on said graphic interface;
including an event window for showing video of said event in each said graphic interface;
allowing each user from said plurality of users to choose to join other said users in said plurality of users, in a participant area depicted on said graphic interface; and
depicting in said graphic interface, a respective user icon of each said user, within a said chosen participant area chosen by that respective user, as a confirmation said respective user has joined said other said users in said participant area.

2. The system of claim 1 including the steps of:
upon an input by a first user having their respective user icon positioned in said participant area to requesting communication with a second user having their respective user icon positioned in said participant area, providing a private communication channel allowing said first said user to directly communicate with said second said user.

3. The system of claim 1 including the steps of:
having a moderator review a choice of each said user to join other said users in said plurality of users in said participant area depicted on said graphic interface, and issuing an approval of said choice; and
depicting said user icon of a respective user whose choice to join other said users failed to receive said approval from said moderator within said lobby as an indication said choice of said user was denied.

4. The system of claim 2 including the steps of:
having a moderator review a choice of each said user to join other said users in said plurality of users in said participant area depicted on said graphic interface, and issuing an approval of said choice; and
depicting said user icon of a respective user whose choice to join other said users failed to receive said approval from said moderator within said lobby as an indication said choice of said user was denied.

5. The system of claim 1 including the steps of:
inputting to said server respective user video streams of said event captured by camera enabled devices of respective video streaming users;
depicting a video stream designator adjacent said user icon of each user having a camera enabled device communicating a said user video stream; and
allowing other said users to choose a said user video stream for depiction in said event window.

6. The system of claim 2 including the steps of:
inputting to said server respective user video streams of said event captured by camera enabled devices of respective video streaming users;
depicting a video stream designator adjacent said user icon of each user having a camera enabled device communicating a said user video stream; and
allowing other said users to choose a said user video stream for depiction in said event window.

7. The system of claim 3 including the steps of:
inputting to said server respective user video streams of said event captured by camera enabled devices of respective video streaming users;
depicting a video stream designator adjacent said user icon of each user having a camera enabled device communicating a said user video stream; and
allowing other said users to choose a said user video stream for depiction in said event window.

8. The system of claim 4 including the steps of:
inputting to said server respective user video streams of said event captured by camera enabled devices of respective video streaming users;
depicting a video stream designator adjacent said user icon of each user having a camera enabled device communicating a said user video stream; and
allowing other said users to choose a said user video stream for depiction in said event window.
